(19) United States
(12) Patent Application Publication
(10) Pub. No.: US 2025/0345799 A1
(43) Pub. Date: Nov. 13, 2025

(54) ANALYZER

(71) Applicant: FUJIFILM CORPORATION, Tokyo (JP)

(72) Inventor: Yoshinori TANAKA, Kanagawa (JP)

(21) Appl. No.: 19/271,805

(22) Filed: Jul. 17, 2025

Related U.S. Application Data
(63) Continuation of application No. PCT/JP2023/044898, filed on Dec. 14, 2023.

(30) Foreign Application Priority Data
Jan. 24, 2023 (JP) 2023-008923

(51) Int. Cl. B01L 7/00; G01N 21/78

(52) U.S. Cl. CPC B01L 7/52; G01N 21/78; B01L 2200/04; B01L 2200/16; B01L 2300/0645; B01L 2300/1805

(57) ABSTRACT

An analyzer includes an incubator that heats, by using a heater, a plurality of analysis chips held in a plurality of cells and a measurement unit that is disposed at a measurement position and that measures a reaction state of each of the plurality of analysis chips. The analysis chips include a first analysis chip, a target temperature to which the first analysis chip is to be heated in measurement being a first target temperature that is relatively high, and a second analysis chip, a target temperature to which the second analysis chip is to be heated in measurement being a second target temperature that is relatively lower than the first target temperature. The table has, as the cells, a first cell that holds the first analysis chip and in which the first analysis chip is heated by the heater to the first target temperature and a second cell that holds the second analysis chip. The table is further provided with a thermal conduction suppressing portion that suppresses thermal conduction from the first cell to the second cell.

### CROSS-REFERENCE TO RELATED APPLICATIONS

This application is a continuation application of International Application No. PCT/JP2023/044898, filed Dec. 14, 2023, the disclosure of which is incorporated herein by reference in its entirety. Further, this application claims priority from Japanese Patent Application No. 2023-008923, filed Jan. 24, 2023, the disclosure of which is incorporated herein by reference in its entirety.

### BACKGROUND

### 1. Technical Field

The present disclosure relates to an analyzer.

### 2. Related Art

An analyzer is known that analyzes a test substance sample by using an analysis chip on which the test substance sample is spotted (see, for example, JP2002-90377A). To analyze the test substance sample, for example, the concentration of a test target analyte contained in the test substance sample is measured by measuring the reaction state between the test substance sample and a reagent. The test substance sample is, for example, blood, urine, or the like. The analysis chip is, for example, a dry analysis chip using a solid-phase reagent.

The analyzer includes an incubator that heats a plurality of analysis chips in order to ensure a suitable measurement condition. The incubator includes, for example, a rotary table on which a plurality of cells that holds the plurality of analysis chips are arranged in a circumferential direction.

A spotting position at which the test substance sample is spotted onto the analysis chips is provided outside the incubator. After the test substance sample has been spotted on the analysis chips at the spotting position, the analysis chips, on each of which the test substance sample has been spotted, are transferred from the spotting position into the incubator by a transfer mechanism. Measurement of the analysis chips is performed in the incubator, and the analysis chips that have been measured are discarded by a discard mechanism.

As measurement methods for such dry analysis chips, there are measurement methods such as a colorimetric method that is an optical measurement method and an electrode method for measuring electrolytes using an electrode. Due to such differences in measurement methods, a target temperature for heating analysis chips during measurement may sometimes vary. Thus, the analyzer described in JP2002-90377A has an incubator for the colorimetric method and an incubator for the electrode method separately.

### SUMMARY

However, a configuration in which a plurality of incubators are provided for each target temperature of a plurality of analysis chips may sometimes hinder size reduction of the analyzer.

The technology of the present disclosure provides an analyzer that can be reduced in size even in the case of using a plurality of analysis chips with different target temperatures for measurement.

A first aspect according to the technology of the present disclosure is an analyzer that analyzes a test substance sample by using a plurality of analysis chips onto which the test substance sample is to be spotted, the plurality of analysis chips being configured to be detachably loaded into the analyzer, the analyzer including an incubator having a heater and a table on which a plurality of cells are arranged such that each of the plurality of cells holds one of the plurality of analysis chips, the table being configured to sequentially transfer the plurality of analysis chips to a measurement position, the incubator being configured to heat the plurality of analysis chips held in the plurality of cells by using the heater and a measurement unit that is disposed at the measurement position and that measures the test substance sample spotted on the plurality of analysis chips. The analysis chips include a first analysis chip, a target temperature to which the first analysis chip is to be heated in measurement being a first target temperature that is relatively high, and a second analysis chip, a target temperature to which the second analysis chip is to be heated in measurement being a second target temperature that is relatively lower than the first target temperature. The table has, as the cells, a first cell that holds the first analysis chip and in which the first analysis chip is heated by the heater to the first target temperature and at least one second cell that holds the second analysis chip, and the table is provided with a thermal conduction suppressing portion that suppresses thermal conduction from the first cell to the at least one second cell.

A second aspect according to the technology of the present disclosure is the analyzer according to the first aspect, in which the thermal conduction suppressing portion is a low thermal conductivity member that has a lower thermal conductivity than the table.

A third aspect according to the technology of the present disclosure is the analyzer according to the second aspect, in which the table is a metal. The low thermal conductivity member is a resin.

A fourth aspect according to the technology of the present disclosure is the analyzer according to the second aspect, in which the table has a first cell region in which a plurality of the first cells are located and a second cell region in which the at least one second cell is located. The low thermal conductivity member is provided between the first cell region and the second cell region.

A fifth aspect according to the technology of the present disclosure is the analyzer according to the fourth aspect, in which the table has a circular shape, and the first cell region and the second cell region are arc-shaped regions arranged circumferentially in the table. A plurality of the low thermal conductivity members are provided on both sides of the second cell region.

A sixth aspect according to the technology of the present disclosure is the analyzer according to the first aspect, in which the measurement unit includes a first measurement unit that optically measures a reaction state of the first analysis chip by using a colorimetric method as a measurement method and a second measurement unit that measures concentration of an electrolyte contained in the test substance sample by using an electrode. The first cell is a cell for use with the colorimetric method, and the at least one second cell is a cell for use with an electrode method.

A seventh aspect according to the technology of the present disclosure is the analyzer according to the second aspect, in which the low thermal conductivity member is also used as a functional member having a function other than low thermal conductivity.

An eighth aspect according to the technology of the present disclosure is the analyzer according to the seventh aspect, in which the functional member also used as the low thermal conductivity member is an optical density plate having a reference optical density that serves as a standard for comparison in a colorimetric method.

A ninth aspect according to the technology of the present disclosure is the analyzer according to the first aspect, in which the plurality of analysis chips held in the plurality of cells of the table are a plurality of types of analysis chips for different measurement items.

A tenth aspect according to the technology of the present disclosure is the analyzer according to the first aspect, in which the table is a rotary table and transfers each of the plurality of cells to the measurement position by rotating.

An eleventh aspect according to the technology of the present disclosure is the analyzer according to the first aspect, in which each of the analysis chips is a dry analysis chip using a solid-phase reagent.

According to the technology of the present disclosure, an analyzer is provided that can be reduced in size even in the case of using a plurality of analysis chips with different target temperatures for measurement.

### BRIEF DESCRIPTION OF THE DRAWINGS

Exemplary embodiments according to the technique of the present disclosure will be described in detail based on the following figures, wherein:

FIG. 1 is a schematic diagram illustrating an overall configuration of an analyzer according to an embodiment;

FIG. 2 is an external perspective view of an incubator;

FIG. 3 is an exploded perspective view of the incubator;

FIG. 4 is a sectional view of the incubator;

FIG. 5 is an external perspective view illustrating a structural example of a colorimetric chip;

FIG. 6 is an external perspective view illustrating a structural example of an electrolyte chip;

FIG. 7 is a schematic diagram illustrating a partial configuration of the analyzer;

FIG. 8 is a plan view illustrating a structural example of a rotary table;

FIG. 9 is a plan view illustrating a configuration example of the analyzer;

FIG. 10 is a conceptual diagram illustrating an example of a temperature change in the rotary table;

FIG. 11 is a schematic diagram illustrating a state of measurement using a colorimetric method in the analyzer; and

FIG. 12 is a schematic diagram illustrating a state of measurement using an electrode method in the analyzer.

### DETAILED DESCRIPTION

An embodiment of the present disclosure will be described in detail below with reference to the drawings.

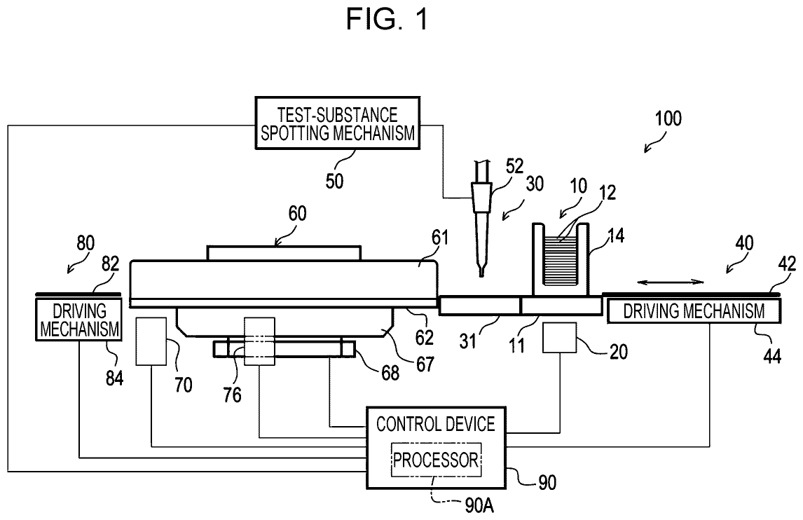

FIG. 1 is a schematic diagram illustrating the overall configuration of an analyzer 100 according to the embodiment.

As an example, as illustrated in FIG. 1, the analyzer 100 is an analyzer that analyzes a test substance sample. The analysis chips 12 are detachably loaded in the analyzer 100. In the analyzer 100, for example, dry analysis chips 12 are used, and the concentration of a test target analyte contained in the test substance sample is measured. When the analysis chips 12 are each in the form of a flat plate, they are also called, for example, slides. The analyzer 100 is an example of an “analyzer” according to the technology of the present disclosure.

Specifically, blood is used as the test substance sample in the analyzer 100, and the concentration of a test target analyte contained in the blood is optically measured. More specifically, the concentration of the test target analyte is measured by a colorimetric method. In the analyzer 100, blood or urine is used as the test substance sample, and the concentration of electrolytes contained in the blood or urine is measured. Specifically, the concentration of ions (e.g., sodium (Na), potassium (K), or chloride (Cl) ions) that are generated by dissociation of electrolytes contained in the blood or urine is electrically measured. More specifically, the concentration of ions subject to measurement using an electrode method is measured.

The analyzer 100 includes a chip set unit 10, a reader 20, a test-substance spotting unit 30, a chip transport mechanism 40, a test-substance spotting mechanism 50, an incubator 60, an optical measurement unit 70, a potential measurement unit 76, a discard mechanism 80, and a control device 90.

In the chip set unit 10, a stocker 14 that accommodates the analysis chips 12 is disposed on a holding base 11. The plurality of analysis chips 12 are stacked and accommodated in the stocker 14. The analysis chips 12 include analysis chips 12A (hereinafter also simply referred to as “colorimetric chips 12A”) that are used for optical concentration measurement using the colorimetric method and an analysis chip 12B (hereinafter also simply referred to as an “electrolyte chip 12B”) that is used for electrolyte concentration measurement using the electrode method. In the following description, when it is not necessary to distinguish between the colorimetric chips 12A and the electrolyte chip 12B, they are collectively referred to as the analysis chips 12. Details of the analysis chips 12 will be described later. The analysis chips 12 are an example of “analysis chips” according to the technology of the present disclosure. The colorimetric chips 12A are each an example of a “first analysis chip” according to the technology of the present disclosure, and the electrolyte chip 12B is an example of a “second analysis chip” according to the technology of the present disclosure.

The reader 20 is, for example, a code reader that reads item information provided on each of the analysis chips 12. Thus, the type and/or lot number or the like of each of the analysis chips 12 is identified. The reader 20 is constituted by, for example, an image sensor such as a charge coupled device (CCD) or a complementary metal oxide semiconductor (CMOS). The item information read by the reader 20 is output to the control device 90.

In the test-substance spotting unit 30, a test substance sample such as blood plasma, whole blood, serum, or urine is spotted onto the analysis chips 12. The test-substance spotting unit 30 is provided with a chip support base 31, and spotting of the test substance sample onto each of the analysis chips 12, which have been transported to the chip support base 31, is performed on the chip support base 31. The spotting of the test substance sample is performed by the test-substance spotting mechanism 50, which will be described later. The chip support base 31 is disposed adjacent to the holding base 11.

The chip transport mechanism 40 transports the analysis chips 12 from the chip set unit 10 to the test-substance spotting unit 30 and further transports them from the test-substance spotting unit 30 to the incubator 60. The chip transport mechanism 40 includes a chip transport member 42 in the form of a thin plate and a driving mechanism 44 that causes the chip transport member 42 to reciprocate in a direction in which the chip set unit 10, the test-substance spotting unit 30, and the incubator 60 are arranged. The driving mechanism 44 is, for example, a linear actuator. The chip transport member 42 is slidably supported by a guide rod (not illustrated) and is caused to reciprocate by the driving mechanism 44.

The test-substance spotting mechanism 50 includes a nozzle 52, a suction and discharge mechanism (not illustrated), and a moving mechanism that moves the nozzle 52. The test-substance spotting mechanism 50 draws in the test substance sample from a test-substance container (not illustrated) and spots the test substance onto the analysis chips 12 in the test-substance spotting unit 30.

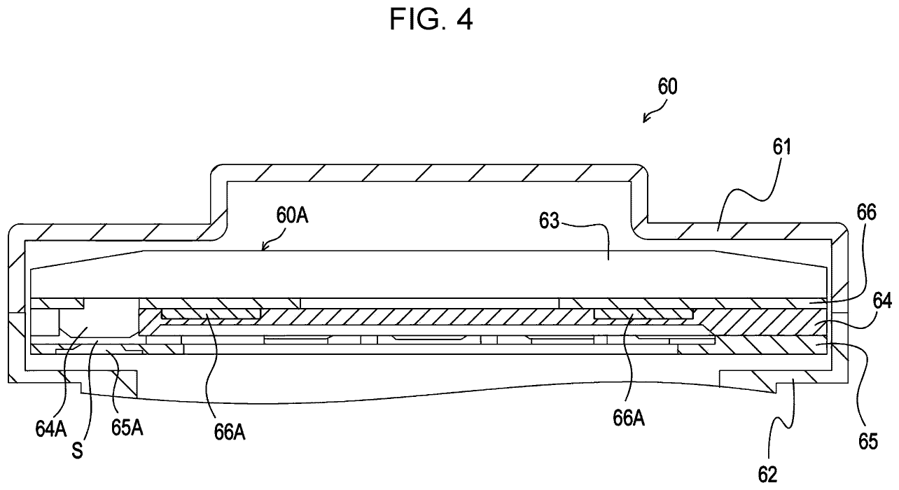

The incubator 60 can accommodate the plurality of analysis chips 12 therein. The incubator 60 has a heater 66A (see FIG. 4) therein and has a function of heating at least a portion inside the incubator 60 where the analysis chips 12 are accommodated to a predetermined target temperature. The incubator 60 further has a function of maintaining the analysis chips 12 at a target temperature. More specifically, the incubator 60 maintains, at a target temperature, an atmosphere around regions of the analysis chips 12 onto which the test substance sample is spotted. As a result, the incubator 60 promotes a reaction between a reagent and the test substance sample on each of the analysis chips 12. The incubator 60 is an example of an “incubator” according to the technology of the present disclosure.

The target temperature varies depending on the type of the analysis chips 12. As mentioned above, as the analysis chips 12, the two types of analysis chips 12, which are the colorimetric chips 12A and the electrolyte chip 12B, are accommodated in the incubator 60 of the present case. The target temperature of the colorimetric chips 12A is, for example, 37° C., and the target temperature of the electrolyte chip 12B is, for example, 30° C. Although the colorimetric chips 12A and the electrolyte chip 12B are arranged within a single space in the incubator 60, they are heated to their respective target temperatures. Details of this matter will be described later.

The incubator 60 includes an upper cover 61 and a lower cover 62. Various members constituting the incubator 60 and the analysis chips 12 are accommodated in a space formed by the upper cover 61 and the lower cover 62. A rotary sleeve 67 is provided at a lower portion of the lower cover 62. A bearing 68 is disposed at a lower portion of an outer periphery of the rotary sleeve 67, and the rotary sleeve 67 is rotatably supported by the bearing 68. A rotational force is transmitted to a member provided inside the incubator 60 via the rotary sleeve 67.

The optical measurement unit 70 is a unit that performs colorimetric measurement, which is an optical density measurement using the colorimetric method, on the analysis chips 12. The potential measurement unit 76 is a unit that performs electrolyte measurement, which is a measurement of electrolyte concentration using an electrode method, on the analysis chips 12. The optical measurement unit 70 and the potential measurement unit 76 are provided below the lower cover 62 at an outer peripheral portion of the incubator 60. Details of the optical measurement unit 70 and the potential measurement unit 76 will be described later. The optical measurement unit 70 and the potential measurement unit 76 are each an example of a “measurement unit” according to the technology of the present disclosure. The optical measurement unit 70 is an example of a “first measurement unit” according to the technology of the present disclosure, and the potential measurement unit 76 is an example of a “second measurement unit” according to the technology of the present disclosure.

The discard mechanism 80 is provided outside the incubator 60 and discards the analysis chips 12 that are located inside the incubator 60 and that have been measured. The discard mechanism 80 includes a chip transport member 82 in the form of a thin plate and a driving mechanism 84 that causes the chip transport member 82 to reciprocate. The driving mechanism 84 is, for example, a linear actuator. The chip transport member 82 is slidably supported by a guide rod (not illustrated) and is caused to reciprocate by the driving mechanism 84.

The control device 90 performs overall operational control of the analyzer 100. Although the configuration of the control device 90 is not particularly limited, the control device 90 is implemented by, for example, a computer including a processor 90A constituted by a central processing unit (CPU), a non-volatile memory (NVM), random-access memory (RAM), and the like.

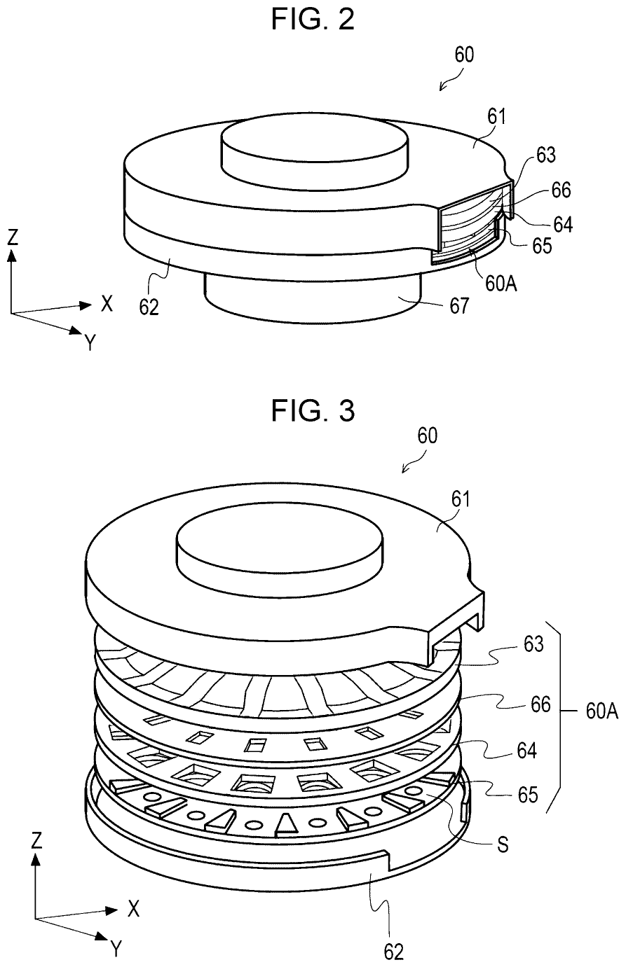

FIG. 2 is an external perspective view of the incubator 60. FIG. 3 is an exploded perspective view of the incubator 60. FIG. 4 is a sectional view of the incubator 60.

As an example, as illustrated in FIG. 2, FIG. 3, and FIG. 4, the incubator 60 has a rotating body 60A that is formed of four disc-shaped members and that is disposed in a space formed between the upper cover 61 and the lower cover 62. The rotating body 60A rotates inside the incubator 60, with a vertical direction (Z direction illustrated in FIG. 2 and FIG. 3) as a direction of a rotational axis. The rotating body 60A includes an upper member 63, a heater pressing member 66, a chip pressing member 64, and a rotary table 65.

The upper member 63 is provided at a topmost portion of the rotating body 60A. An opening (not illustrated) is formed at the center of the rotating body 60A including the upper member 63, and a cable for supplying power to the heater 66A and the like is disposed through the opening.

The heater pressing member 66 is provided between the upper member 63 and the chip pressing member 64. The heater pressing member 66 presses the heater 66A from above, the heater 66A being disposed between the heater pressing member 66 and the chip pressing member 64. The heater 66A functions as a heat source for heating the interior of the incubator 60 to a predetermined target temperature. The heater 66A is, for example, a ceramic heater. The heater 66A is located below the inner peripheral side of the heater pressing member 66. Heat that is generated from the heater 66A is transferred through the members inside the incubator 60, so that the internal space of the incubator 60 including cells S is set to the predetermined target temperature. The heater 66A is an example of a “heater” according to the technology of the present disclosure.

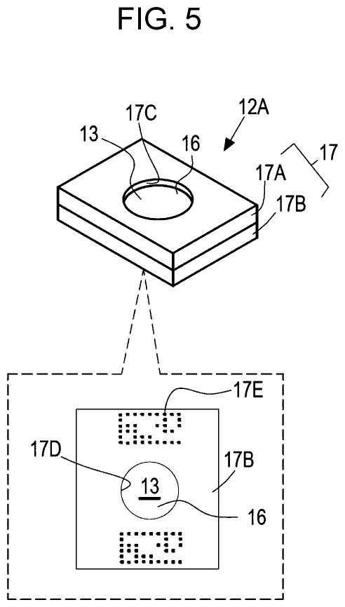

The chip pressing member 64 is provided between the heater pressing member 66 and the rotary table 65. The chip pressing member 64 presses the analysis chips 12, which are placed on the rotary table 65, from above. This suppresses displacement of the analysis chips 12 on the rotary table 65. In addition, the chip pressing member 64 covers a reaction region 13 (see FIG. 5) of each of the analysis chips 12 so as to suppress evaporation of the test substance sample spotted on the analysis chip 12.

The rotary table 65 is a table on which the analysis chips 12 are placed. The rotary table 65 has the cells S that are a plurality of regions partitioned from each other along a circumferential direction, and each of the analysis chips 12 can be accommodated in one of the cells S. The rotary table 65 is an example of a “table” and a “rotary table” according to the technology of the present disclosure.

As illustrated in FIG. 4, the heater 66A is disposed at a position where it faces a circumference that is located inside the circumference along which the plurality of cells S are arranged. The heat of the heater 66A is transferred to the chip pressing member 64 and the rotary table 65. These generate heat, so that the temperature inside the incubator 60 increases. The heat transferred to the rotary table 65 is also transferred to the analysis chips 12 placed on the rotary table 65 in such a manner as to directly heat the analysis chips 12. As a result, the portion in which the analysis chips 12 are accommodated is heated to the target temperature, and the atmosphere around the regions onto which the test substance sample is spotted is maintained at the target temperature.

As described above, the analysis chips 12 include the colorimetric chips 12A and the electrolyte chip 12B. FIG. 5 is an external perspective view illustrating a structural example of the colorimetric chips 12A. As illustrated in FIG. 5 as an example, each of the colorimetric chips 12A has the reaction region 13 in which the reagent is immobilized. The reagent reacts with the test target analyte so as to produce a substance that develops a specific color. The substance that develops color by this reaction will hereinafter be referred to as a reactant. As the reagent, for example, a solid-phase dry reagent that is in a dry state at least at the time of shipment is used. The test substance sample is spotted onto the reaction region 13 of each of the colorimetric chips 12A.

Each of the colorimetric chips 12A has a carrier 16 onto which the test substance sample is spotted, and the carrier 16 is accommodated in a case 17. The case 17 is constituted by a first case 17A and a second case 17B, and the carrier 16 is accommodated by being sandwiched between the first case 17A and the second case 17B. The first case 17A has an opening 17C that functions as a drop port for spotting the test substance sample onto the reaction region 13. The second case 17B has an opening 17D for irradiating light onto the reaction region 13. The carrier 16 is exposed through the opening 17C of the first case 17A, which constitutes front surface of the colorimetric chip 12A. In addition, the carrier 16 is exposed through the opening 17D of the second case 17B, which constitutes a rear surface of the colorimetric chip 12A. A region in which the carrier 16 is exposed through the opening 17D constitutes the reaction region 13 where the reagent is immobilized. The second case 17B is provided with an information code 17E in which item information relating to measurement items are encoded. The information code 17E is, for example, a pattern in which a plurality of dots are arranged, and the dot arrangement pattern differs for each measurement item. Obviously, a one-dimensional barcode, a two-dimensional barcode, or the like may be used as the information code 17E.

By changing the reagent that reacts with the test substance sample, test substance sample can be analyzed for a plurality of measurement items. Two or more of the colorimetric chips 12A are prepared for each measurement item, and a reagent corresponding to the measurement item is immobilized on the carriers 16 of the colorimetric chips 12A. The item information provided on each of the colorimetric chips 12A includes identification information of the reagent immobilized on the carrier 16 of the colorimetric chip 12A (e.g., information capable of specifying that can identify the name and identification code of the reagent), or identification information of the measurement item measured by the reagent (e.g., information that can identify the name and identification code of the item).

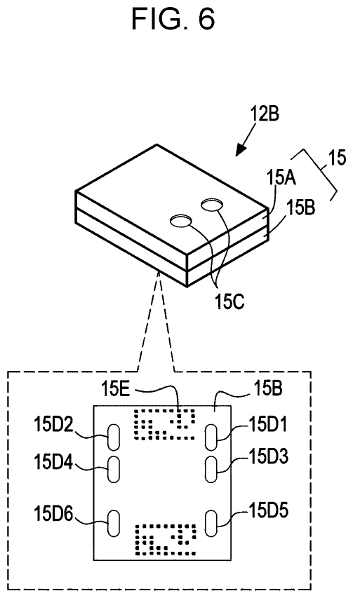

FIG. 6 is an external perspective view illustrating a structural example of the electrolyte chip 12B.

As illustrated in FIG. 6 as an example, the electrolyte chip 12B has, inside a case 15, multilayer film electrodes (not illustrated) and a distribution member (not illustrated) that correspond to ions to be measured (e.g., Na ions, K ions, and Cl ions). The case 15 is constituted by a first case 15A and a second case 15B, and the multilayer film electrodes and the distribution member are accommodated by being sandwiched between the first case 15A and the second case 15B. The first case 15A has two openings 15C. The test substance sample is spotted onto one of the openings 15C, and a reference solution is spotted onto the other opening 15C. The distribution member delivers the test substance sample to one ends of the multilayer film electrodes and the reference solution to the other ends of the multilayer film electrodes.

The second case 15B has holes 15D corresponding to the number of the multilayer film electrodes. Measurement electrodes (not illustrated) are capable of coming into contact with the one ends and the other ends of the multilayer film electrodes via the holes 15D. In the case illustrated in FIG. 6, six holes 15D1 to 15D6 are formed. For example, the holes 15D1 and 15D2 respectively communicate with one end and the other end of the multilayer film electrode for measuring Cl ion concentration. In addition, the holes 15D3 and 15D4 respectively communicate with one end and the other end of the multilayer film electrode for measuring K ion concentration. Furthermore, the holes 15D5 and 15D6 respectively communicate with one end and the other end of the multilayer film electrode for measuring Na ion concentration.

The second case 15B is provided with an information code 15E in which item information relating to measurement items are encoded. The information code 15E has a configuration and a function that are similar to those of the information code 17E provided on each of the colorimetric chips 12A.

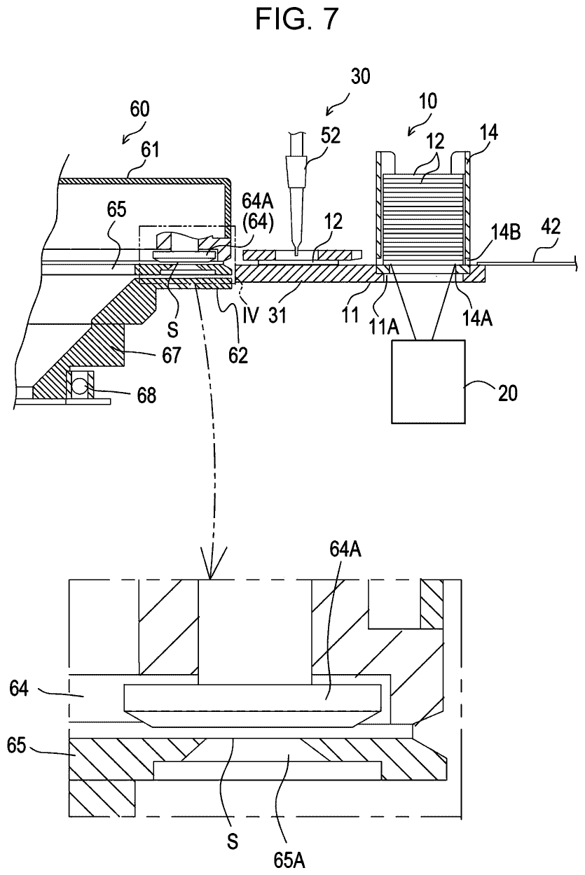

FIG. 7 is a schematic diagram illustrating a partial configuration of the analyzer 100.

As illustrated in FIG. 7 as an example, a side wall of the stocker 14 has an insertion port 14B into which the chip transport member 42 is inserted. The chip transport member 42 is inserted into the stocker 14 through the insertion port 14B.

The stocker 14 has an opening 14A formed in a bottom surface thereof. Each of the colorimetric chips 12A is accommodated in a position in which its surface on which the information code 17E has been recorded faces toward the opening 14A of the stocker 14. Accordingly, in the stocker 14, the information code 17E of the lowermost colorimetric chip 12A that is closest to the opening 14A is exposed through the opening 14A. Similarly, the holding base 11, on which the stocker 14 is disposed, has an opening 11A. Thus, the information code 17E of the lowermost colorimetric chip 12A in the stocker 14 is exposed toward the reader 20 through the opening 11A of the holding base 11 and the opening 14A of the stocker 14. The reader 20 is disposed below the holding base 11 and reads the information code 17E that is exposed through the opening 11A and the opening 14A. Here, a case has been described in which the information code 17E of each of the colorimetric chips 12A is read by the reader 20, and the same applies to the information code 15E of the electrolyte chip 12B.

The chip transport member 42 is pressed against the lowermost analysis chip 12 among the analysis chips 12, which are accommodated and stacked on top of one another. In this state, the chip transport member 42 moves toward the incubator 60, so that the analysis chip 12 passes over the chip support base 31 and transported into the incubator 60.

The incubator 60 has the chip pressing member 64 that presses the analysis chips 12, which are loaded in the cells S, from above. The chip pressing member 64 has a plurality of protrusions 64A each of which is arranged at a position where it faces one of the cells S. The protrusions 64A are biased downward by a biasing member (not illustrated). A slit-shaped space is formed between the protrusions 64A and the cells S, and the analysis chips 12 are loaded in this space. The protrusions 64A press the analysis chips 12, which are loaded in the cells S, from above. This suppresses movement of each of the analysis chips 12 in the corresponding cell S (e.g., displacement of the analysis chip 12 in the radially outward direction due to centrifugal force generated on the analysis chip 12 as a result of rotation of the rotary table 65).

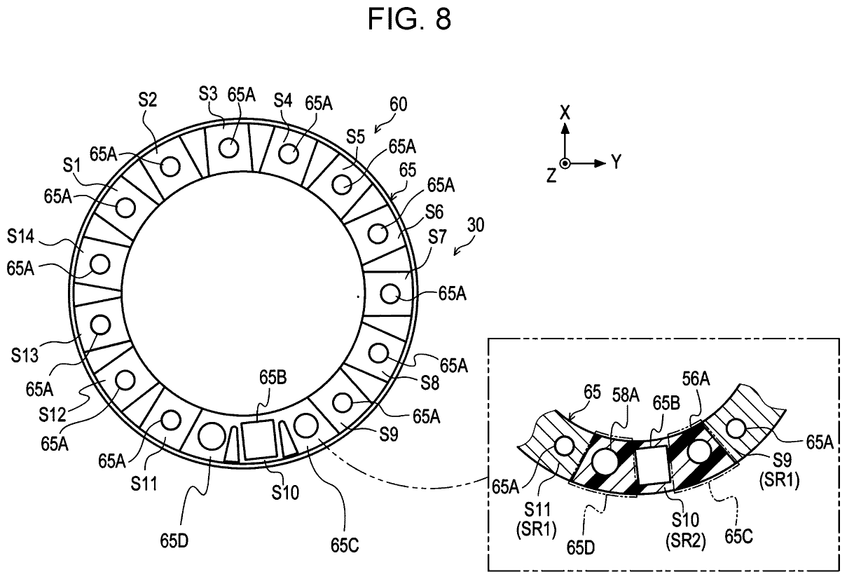

FIG. 8 is a plan view illustrating a structural example of the rotary table 65.

As illustrated in FIG. 8 as an example, the rotary table 65 is provided with a plurality of cells S1 to S14 in which the analysis chips 12 are to be loaded. In the case illustrated in FIG. 8, the rotary table 65 has an annular shape, and the 14 cells S1 to S14 are arranged thereon in the circumferential direction. The rotary table 65 rotates with the vertical direction (Z direction illustrated in FIG. 8) as a rotational axis and sequentially transports the analysis chips 12 placed on the plurality of cells S to a measurement position (i.e., a position that faces the optical measurement unit 70 or the potential measurement unit 76). The plurality of analysis chips 12 on the rotary table 65 are heated to a predetermined temperature in the incubator 60. In the following description, when it is necessary to distinguish among the plurality of cells S1 to S14, sub-reference numerals 1 to 14 are assigned to them. When such distinction is unnecessary, they will be simply referred to as the cells S.

The cells S1 to S9 and S11 to S14 of the rotary table 65 hold the colorimetric chips 12A. An opening window 65A for photometric measurement is formed at the center of a bottom surface of each of the cells S1 to S9 and S11 to S14, and the reflection optical density of each of the colorimetric chips 12A is measured by the optical measurement unit 70 through the corresponding opening window 65A. The cells S1 to S9 and S11 to S14 are each an example of a “first cell” according to the technology of the present disclosure.

The cell S10 of the rotary table 65 holds the electrolyte chip 12B. An opening window 65B for potential measurement is formed in a bottom surface of the cell S10. The ion concentration of the electrolyte chip 12B is measured by the potential measurement unit 76 through the opening window 65B. The cell S10 is an example of a “second cell” according to the technology of the present disclosure.

In the rotary table 65, an arc-shaped region including the cells S1 to S9 and S11 to S14 will be referred to as a first cell region SR1, and an arc-shaped region including the cell S10 will be referred to as a second cell region SR2. In this case, low thermal conductivity members 65C and 65D are provided on both sides of the second cell region SR2 of the rotary table 65 in the circumferential direction, adjacent thereto. In other words, the low thermal conductivity members 65C and 65D are provided between the first cell region SR1 and the second cell region SR2. In the case illustrated in FIG. 8, the low thermal conductivity members 65C and 65D are provided on both sides of the cell S10.

As described above, the rotary table 65 is heated by the heater 66A and generates heat. Although the entire region of the rotary table 65 including the first cell region SR1 and the second cell region SR2 generates heat, thermal conduction from the first cell region SR1 to the second cell region SR2 is suppressed by the low thermal conductivity members 65C and 65D. In other words, thermal conduction from the cells S1 to S9 and S11 to S14 to the cell S10 is suppressed.

The colorimetric chips 12A, which are set in the first cell region SR1 (including, for example, the cells S1 to S9 and S11 to S14), and the electrolyte chip 12B, which is set in the second cell region SR2 (including, for example, the cell S10) have different target temperatures to which they are to be heated during measurement. As an example, a first target temperature that is the target temperature of the colorimetric chips 12A is 37° C., and a second target temperature that is the target temperature of the electrolyte chip 12B is 30° C. The first cell region SR1 and the second cell region SR2 are regions of the single rotary table 65, and the two types of analysis chips 12 (i.e., the colorimetric chips 12A and the electrolyte chip 12B) having different target temperatures are accommodated in a space of the single incubator 60. Even in such a configuration, the low thermal conductivity members 65C and 65D are provided in order to maintain the colorimetric chips 12A to at the first target temperature and maintain the electrolyte chip 12B at the second target temperature, which is lower than the first target temperature, so that thermal conduction from the first cell region SR1 to the second cell region SR2 is suppressed.

The first cell region SR1 is an example of a “first cell region” according to the technology of the present disclosure, and the second cell region SR2 is an example of a “second cell region” according to the technology of the present disclosure.

The low thermal conductivity members 65C and 65D are members each having a thermal conductivity lower than that of the rotary table 65. In the case illustrated in FIG. 8, the rotary table 65 is made of a metal material (e.g., aluminum), and the low thermal conductivity members 65C and 65D are made of a resin material. An example of the resin is a poly-oxy-methylene (POM) resin and an acrylonitrile-butadiene-styrene (ABS) resin. The low thermal conductivity members 65C and 65D are each an example of a “thermal conduction suppressing portion” and a “low thermal conductivity member” according to the technology of the present disclosure.

In the present embodiment, the phrase “the rotary table 65 is made of a metal material” includes not only the case where all portions constituting the rotary table 65 are made of a metal material, but also the case where a portion of the rotary table 65 is made of a material other than a metal material within a range generally acceptable in the technical field to which the technology of the present disclosure belongs and without departing from the spirit of the technology of the present disclosure. Similarly, in the present embodiment, the phrase “the low thermal conductivity members 65C and 65D are made of a resin material” includes not only the case where all portions constituting the low thermal conductivity members 65C and 65D are made of a resin material, but also the case where a portion of the low thermal conductivity members 65C and 65D is made of a material other than a resin material within a range generally acceptable in the technical field to which the technology of the present disclosure belongs and without departing from the spirit of the technology of the present disclosure.

Although a configuration example has been described above in which the rotary table 65 is made of a metal material and in which the low thermal conductivity members 65C and 65D are made of a resin material, this is merely an example. The rotary table 65 may be made of a metal material (e.g., aluminum), and the low thermal conductivity members 65C and 65D may be made of a metal material (e.g., a stainless steel) having a thermal conductivity lower than that of the metal material used for the rotary table 65. Alternatively, the rotary table 65 may be made of a resin material, and the low thermal conductivity members 65C and 65D may be made of a resin material having a thermal conductivity lower than that of the resin material used for the rotary table 65.

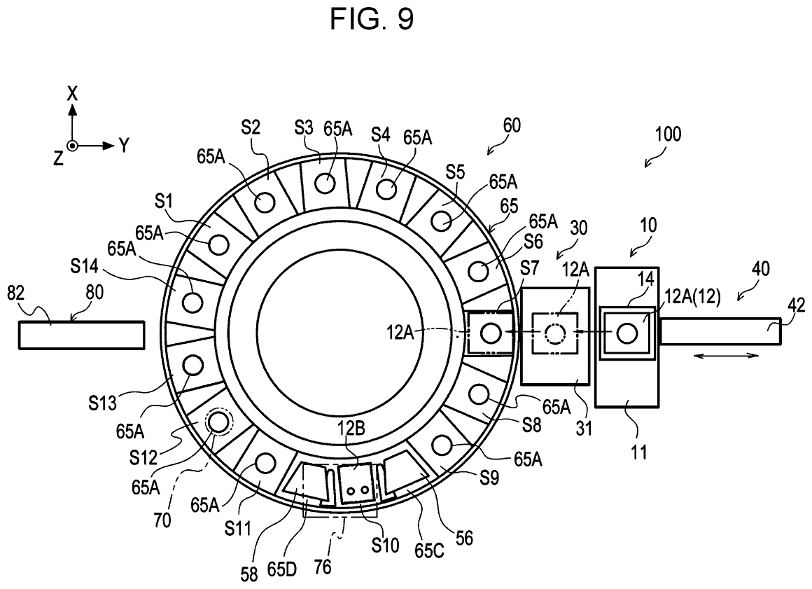

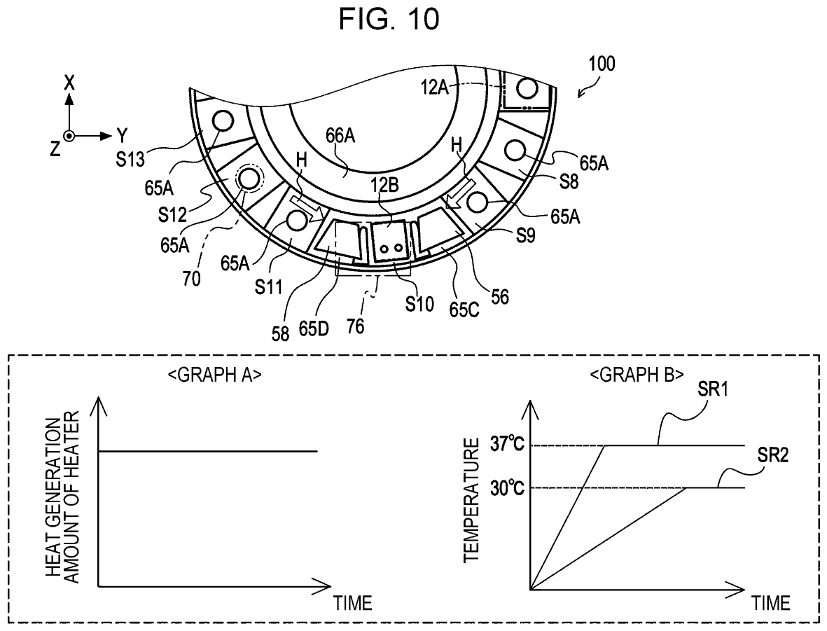

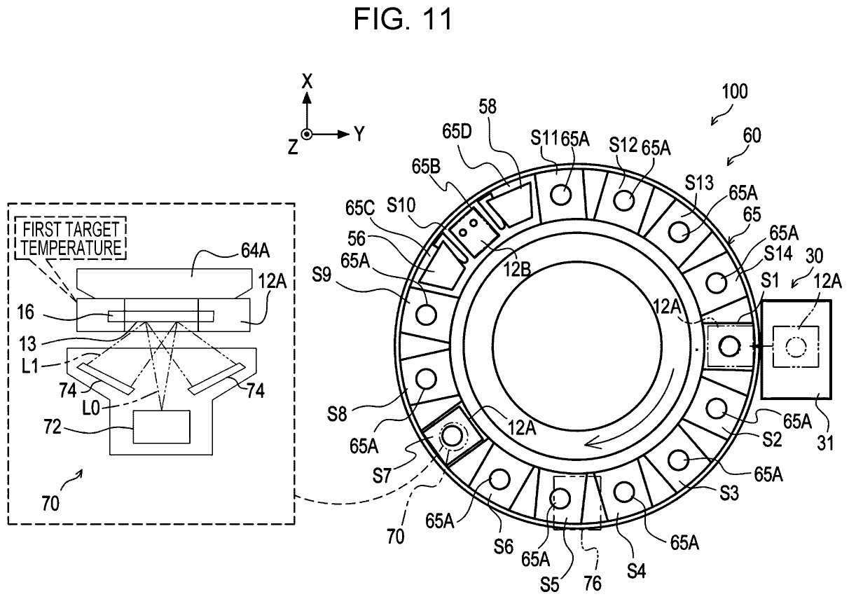

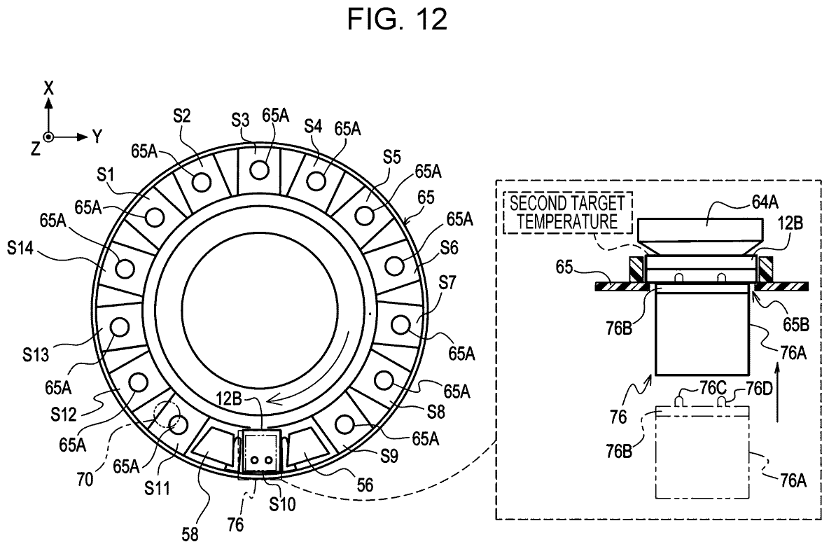

FIG. 9 is a plan view illustrating a configuration example of the analyzer 100. FIG. 10 is a conceptual diagram illustrating an example of a temperature change in the analyzer 100. FIG. 11 is a schematic diagram illustrating a state of measurement using the colorimetric method in the analyzer 100. FIG. 12 is a schematic diagram illustrating a state of measurement using the electrode method in the analyzer 100.

As illustrated in FIG. 9 as an example, one of the colorimetric chips 12A is taken out from the stocker 14 and then transported to the spotting position on the chip support base 31 by the chip transport mechanism 40. At the spotting position, the test substance is spotted onto the colorimetric chip 12A by the test-substance spotting unit 30. After the spotting has been performed on the colorimetric chip 12A, the colorimetric chip 12A is transported into the incubator 60. In the case illustrated in FIG. 9, the colorimetric chip 12A is loaded in the cell S7.

Similar to the colorimetric chips 12A, the electrolyte chip 12B is also transported to the spotting position on the chip support base 31 by the chip transport mechanism 40, and the test substance is spotted at the spotting position. After the test substance has been spotted, the electrolyte chip 12B is transported into the incubator 60. In the case illustrated in FIG. 9, the electrolyte chip 12B is loaded in the cell S10. Obviously, when the electrolyte chip 12B is loaded into the cell S10 from the spotting position, this loading operation is performed in a state where the cell S10 is located at a position corresponding to the spotting position like the cell S7 illustrated in FIG. 9.

In order to avoid complexity in the drawings and for convenience of description, FIG. 9 to FIG. 12 illustrate a case in which one of the colorimetric chips 12A is held in the single cell S7 of the rotary table 65 and in which the electrolyte chip 12B is held in the cell S10. However, the plurality of cells capable of holding the colorimetric chips 12A are provided in the first cell region SR1, and thus, in practice, the plurality of colorimetric chips 12A are held.

As illustrated in FIG. 10 as an example, after the analysis chips 12 have been transported into the incubator 60, the analysis chips 12 are heated by the heat generated by the heater 66A inside the incubator 60.

As illustrated in Graph A in FIG. 10, for example, the amount of the heat generated by the heater 66A per unit time is constant. The rotary table 65 is heated by the heater 66A, and the heat transferred to the rotary table 65 raises the temperature of the analysis chips 12 and the temperature of the atmosphere around the analysis chips 12. In the rotary table 65, the entire region including the first cell region SR1 and the second cell region SR2 generates heat. However, the low thermal conductivity members 65C and 65D are provided between the first cell region SR1 and the second cell region SR2. Consequently, the manner in which the heat is transferred to the first cell region SR1 and to the second cell region SR2 is not uniform. Specifically, thermal conduction from the first cell region SR1 to the second cell region SR2 is suppressed by the low thermal conductivity members 65C and 65D. Therefore, an increase in the temperature of the second cell region SR2 is relatively reduced with respect to an increase in the temperature of the first cell region SR1.

Specifically, as illustrated in Graph B in FIG. 10, the temperature of the first cell region SR1 increases to 37° C., which is an example of the first target temperature. In contrast, the temperature of the second cell region SR2 does not reach the first target temperature and instead remains at 30° C., which is an example of the second target temperature lower than the first target temperature. Thus, the colorimetric chips 12A held in the cell S7 and the like of the first cell region SR1 are heated to the first target temperature. In contrast, the electrolyte chip 12B held in the cell S10 of the second cell region SR2 is heated to the second target temperature. In this manner, by providing the low thermal conductivity members 65C and 65D, each of which is an example of the thermal conduction suppressing portion, even in the case where the plurality of analysis chips 12 having different target temperatures are accommodated in the single incubator 60, the analysis chips 12 can be heated to their respective target temperatures.

In addition to the amount of heat generated by the heater 66A, the size, material, and the like that define the thermal conductivity of each of the low thermal conductivity members 65C and 65D are appropriately set in accordance with the first target temperature and the second target temperature.

As illustrated in FIG. 11 as an example, one of the colorimetric chips 12A to be measured is transported to a measurement position for measurement using the colorimetric method by rotation of the rotary table 65. Then, the measurement using the colorimetric method is performed on the colorimetric chip 12A, which has been heated to the first target temperature. The optical measurement unit 70 irradiates each of the colorimetric chips 12A with light (measurement light L0, which will be described later as an example) and receives light reflected from the colorimetric chip 12A. As a result, the optical measurement unit 70 measures the optical density corresponding to the reaction state between the test substance sample and the reagent in each of the colorimetric chips 12A. The optical measurement unit 70 includes a light source 72 and photodetectors 74. The light source 72 irradiates the reaction region 13 with the measurement light L0, and the photodetectors 74 receive light from the reaction region 13 and perform photoelectric conversion.

The light source 72 irradiates light toward the reaction region 13 through the opening 17D of the case 17 of the colorimetric chip 12A. The wavelength range of the light is determined in accordance with the test target analyte (i.e., measurement item). For example, in the present case, a reactant that develops a specific color is produced as a result of a reaction between the test target analyte and the reagent as described above. Since the light irradiated by the light source 72 is light for detecting whether a reactant is generated, the wavelength range is determined in accordance with the color developed by the reactant. The measurement light L0 in the present case is, for example, light including a wavelength range that is absorbed by the reactant for the purpose of detecting the reactant.

It is preferable that the wavelength range of the measurement light L0 be limited to a wavelength range that is absorbed by the reactant. As the light source 72, for example, a light source such as a light emitting diode (LED), an organic electroluminescence (EL) device, or a semiconductor laser is used. A light source, such as a white light source, that emits light over a relatively broad wavelength range and a band-pass filter that transmits only a specific wavelength range may be combined together so as to generate a measurement light restricted to a specific wavelength range. In FIG. 11, only the single light source 72 is illustrated. However, in practice, in order to measure the plurality of measurement items, a plurality of light sources 72 that output a plurality of light beams in different wavelength ranges are provided, or a single white light source and a plurality of band-pass filters that transmit a plurality of light beams in different wavelength ranges may be provided.

The photodetectors 74 detect the output light L1 emitted by the colorimetric chip 12A when the colorimetric chip 12A is irradiated with the measurement light L0. The photodetectors 74 are light-receiving elements (e.g., photodiodes or the like) that output detection signals corresponding to the amount of light. In the present case, the two photodetectors 74 are provided. The photodetectors 74 output the detection signals to the control device 90 (see FIG. 1). The control device 90 obtains the detection signals corresponding to the output light L1 and derives the concentration of the test target analyte.

In the reaction region 13, a reaction occurs between the test substance sample and the reagent, resulting in the generation of a reactant that develops a specific color. As the reactant is generated, the color of the reaction region 13 changes, and this color change appears as a change in the optical density of the reaction region 13. The output light L1 is light that corresponds to the optical density of the reaction region 13 and reflects information regarding the reactant due to occurrences such as light absorption by the reactant. The optical density of the reaction region 13 changes in accordance with the amount of the reactant, and the amount of the reactant indicates the concentration of the test target analyte in the test substance sample. Thus, the concentration of the test target analyte can be measured on the basis of the detection signals representing the output light L1, which includes the information regarding the reactant.

A black density plate 56 and a white density plate 58 are provided on both sides of the cell S10. Opening windows 56A and 58B (see FIG. 8) are formed below the black density plate 56 and the white density plate 58, respectively. The black density plate 56 and the white density plate 58 are each a density plate for obtaining a reference optical density that is referred to when the optical density of each of the colorimetric chips 12A is measured. Before measuring the optical density of each of the colorimetric chips 12A, the optical measurement unit 70 irradiates each of the black density plate 56 and the white density plate 58 with the measurement light L0 so as to measure a black reference optical density and a white reference optical density. The optical density of each of the colorimetric chips 12A is measured as a relative density within a range defined by the black reference optical density as a lower limit and the white reference optical density as an upper limit. As will be described later, the optical measurement unit 70 has a plurality of light sources that emit the measurement light L0 of a plurality of different wavelengths, and each of the wavelengths is used in accordance with the type of the colorimetric chips 12A (i.e., measurement item). The black reference optical density and the white reference optical density are measured for each wavelength of the measurement light L0.

Here, the black density plate 56 and the white density plate 58 are formed on their respective sides of the cell S10 as mentioned above. In other words, the black density plate 56 and the white density plate 58 are provided between the first cell region SR1 and the second cell region SR2. The black density plate 56 and the white density plate 58 are made of a material (e.g., a resin material) having a thermal conductivity lower than that of the rotary table 65. Thus, the low thermal conductivity members 65C and 65D also function as the black density plate 56 and the white density plate 58. In other words, portions of the low thermal conductivity members 65C and 65D are the black density plate 56 and the white density plate 58. In this manner, the low thermal conductivity members 65C and 65D are also used as functional members with properties other than low thermal conductivity.

For example, the measurement using the colorimetric method, which is the measurement of the optical density of the plurality of colorimetric chips 12A on the rotary table 65 is performed multiple times at predetermined intervals while the rotary table 65 is being rotated. When the number of measurements reaches a predetermined number, the measurement using the colorimetric method is terminated. Then, the concentration of the test target analyte is derived on the basis of a plurality of detection signals corresponding to the optical density values measured in the multiple measurements.

Each of the colorimetric chips 12A that has undergone the measurement using the colorimetric method is transported by the rotary table 65 to a position where the colorimetric chip 12A can be transported toward a discard position. After that, the colorimetric chip 12A is transported by the discard mechanism 80 (see FIG. 9 and the like) from the inside of the incubator 60 to the discard position. For example, the discard position is a region that is provided inside the rotary table 65 of the incubator 60. The chip transport member 82 pushes the colorimetric chip 12A, so that the colorimetric chip 12A moves from the inside of the incubator 60 toward the discard position.

The electrolyte chip 12B is taken out from the stocker 14 and then transported to the spotting position on the chip support base 31 by the chip transport mechanism 40. At the spotting position, the test substance sample and the reference solution are spotted onto the electrolyte chip 12B by the test-substance spotting unit 30. After the spotting has been performed on the electrolyte chip 12B, the electrolyte chip 12B is transported into the incubator 60. In the case illustrated in FIG. 12, the electrolyte chip 12B is loaded in the cell S10. As described above, thermal conduction from the first cell region SR1 to the cell S10 is suppressed by the low thermal conductivity members 65C and 65D. Therefore, the temperature rise of the electrolyte chip 12B loaded in the cell S10 is limited to the second target temperature.

As illustrated in FIG. 12 as an example, after the electrolyte chip 12B has been transported into the incubator 60, the electrolyte chip 12B is transported to a measurement position for measurement using the electrode method by rotation of the rotary table 65. A potential measurement using the electrode method is performed on the electrolyte chip 12B that has been heated to the second target temperature. The potential measurement unit 76 includes a unit main body 76A, a temperature-controlled portion 76B, and electrode pins 76C and 76D. When the electrolyte chip 12B is transported to the measurement position, the unit main body 76A moves toward the electrolyte chip 12B. Then, the unit main body 76A brings the temperature-controlled portion 76B into contact with the electrolyte chip 12B through the opening window 65B, and in addition, inserts the electrode pins 76C and 76D into the holes 15D of the electrolyte chip 12B (see FIG. 6) of the electrolyte chip 12B.

The temperature-controlled portion 76B is heated to the second target temperature (e.g., 30° C.) like the second cell region SR2. The temperature-controlled portion 76B is, for example, a metal plate that transfers heat generated by a heat source accommodated in the unit main body 76A. Thus, even when the electrolyte chip 12B, which has been heated to the second target temperature by the heater 66A, comes into contact with the temperature-controlled portion 76B, a decrease in the temperature of the electrolyte chip 12B is suppressed. The potential measurement is performed on the electrolyte chip 12B by using the electrode pins 76C and 76D.

The electrode pins 76C and 76D are a pair of electrode pins. The electrode pins 76C and 76D come into contact with the one ends and the other ends of the multilayer film electrodes through the holes 15D of the electrolyte chip 12B. As a result, a potential difference generated across the multilayer film electrodes is measured. The potential difference varies in accordance with the ion concentration in the test substance sample. Thus, by measuring the potential difference, the ion concentration in the test substance sample can be determined.

The electrode pins 76C and 76D are provided so as to correspond to the number of the holes 15D of the electrolyte chip 12B. For example, in the case where the six holes 15D1 to 15D6 are formed in the electrolyte chip 12B as described above, three pairs of the electrode pins 76C and 76D are provided. One of these pairs is inserted into the holes 15D1 and 15D2, with one pin in each hole. As a result, the Cl ion concentration is measured. Another pair is inserted into the holes 15D3 and 15D4, with one pin in each hole. The K ion concentration is measured. Another pair is inserted into the holes 15D5 and 15D6, with one pin in each hole. The Na ion concentration is measured. In this manner, the concentrations of a plurality of types of ions are simultaneously measured.

After the measurement using the potential measurement unit 76 has been completed, the unit main body 76A moves away from the electrolyte chip 12B. Then, the electrolyte chip 12B is discarded from the inside of the incubator 60 by the discard mechanism 80.

As described above, in the analyzer 100 according to the present embodiment, the rotary table 65 provided inside the incubator 60 includes the cells S1 to S9 and S11 to S14 that holds the colorimetric chips 12A and the cell S10 that holds the electrolyte chip 12B. In addition, the rotary table 65 includes the low thermal conductivity members 65C and 65D that suppress thermal conduction from the cells S1 to S9 and S11 to S14 to the cell S10. Here, the cells S1 to S9 and S11 to S14, into which the colorimetric chips 12A are loaded, are set to the first target temperature (e.g., 37° C.) for measurement using the colorimetric method. In contrast, the cell S10, into which the electrolyte chip 12B is loaded, is set to the second target temperature (e.g., 30° C.) for potential measurement. In this configuration, the rotary table 65 is provided with the low thermal conductivity members 65C and 65D. Consequently, even in the case where the colorimetric chips 12A and the electrolyte chip 12B having different target temperatures are used, it is not necessary to provide a plurality of incubators in accordance with the target temperatures. In other words, in the incubator 60, the colorimetric chips 12A and the electrolyte chip 12B can be set to different target temperatures. Therefore, it is not necessary to provide a plurality of incubators for each target temperature, thereby enabling size reduction.

In the analyzer 100 according to the present embodiment, the low thermal conductivity members 65C and 65D are members each having a thermal conductivity lower than that of the rotary table 65. Consequently, for example, compared with the case where thermal conduction from the cells S1 to S9 and S11 to S14 to the cell S10 is suppressed by using a cooling element, the configuration of the rotary table 65 can be simplified.

In the analyzer 100 according to the present embodiment, the rotary table 65 is made of a metal material, and the low thermal conductivity members 65C and 65D are made of a resin material. This can contribute to a reduction in the cost of the analyzer 100, an improvement in the formability of the rotary table 65, and/or a reduction in the weight of the analyzer 100 compared with the case where the low thermal conductivity members 65C and 65D are made of a metal material.

In the analyzer 100 according to the present embodiment, the rotary table 65 has the first cell region SR1, in which the cells S1 to S9 and S11 to S14 are arranged, and the second cell region SR2, in which the cell S10 is arranged, and the low thermal conductivity members 65C and 65D are provided between the first cell region SR1 and the second cell region SR2. As a result, for example, compared with the case where the low thermal conductivity members 65C and 65D are provided in a location other than between the first cell region SR1 and the second cell region SR2, thermal conduction from the cells S1 to S9 and S11 to S14 to the cell S10 is suppressed.

In the analyzer 100 according to the present embodiment, the rotary table 65 is has a circular shape, and the first cell region SR1 and the second cell region SR2 are arc-shaped regions arranged circumferentially in the rotary table 65. The low thermal conductivity members 65C and 65D are provided on both sides of the second cell region SR2. As a result, for example, compared with the case where the low thermal conductivity member 65C is provided on only one side of the second cell region SR2, thermal conduction from the cells S1 to S9 and S11 to S14 to the cell S10 is suppressed.

In the analyzer 100 according to the present embodiment, the optical measurement unit 70 and the potential measurement unit 76 are provided. The cells S1 to S9 and S11 to S14 of the rotary table 65 are the cells to be used for measurement using the colorimetric method, and the cell S10 is a cell to be used for measurement using the electrode method. The target temperature in the measurement that is performed by the optical measurement unit 70 and the target temperature in the measurement that is performed by the potential measurement unit 76 differ from each other. Thus, it is necessary to control the cells S, which are to be used for their respective measurements, at different temperatures. Therefore, in the case where the analyzer 100 includes measurement units that employ different measurement methods, by applying this configuration, temperature control according to the measurement method can be easily performed.

In the analyzer 100 according to the present embodiment, the low thermal conductivity members 65C and 65D are also used as functional members having a function other than low thermal conductivity. This achieves simplification of the configuration of the rotary table 65 by using functional members as the low thermal conductivity members 65C and 65D compared with a case where functional members are provided separately as dedicated members.

For example, in the case where the low thermal conductivity members 65C and 65D are provided on the rotary table 65 and where an additional functional member is further provided, the number of components of the rotary table 65 increases. In addition, it is necessary to prepare a space for the functional member, resulting in an increase in the size of the rotary table 65 is increased. In this configuration, since the low thermal conductivity members 65C and 65D are also used as functional members having a function other than low thermal conductivity, an increase in the number of components of the rotary table 65 is suppressed, and in addition, a reduction in the size of the rotary table 65 is achieved.

In the analyzer 100 according to the present embodiment, the functional members that also serve as the low thermal conductivity members 65C and 65D are the black density plate 56 and the white density plate 58. This achieves simplification of the configuration of the rotary table 65 compared with the case where the black density plate 56 and the white density plate 58 are provided in addition to the low thermal conductivity members 65C and 65D.

In the analyzer 100 according to the present embodiment, the plurality of analysis chips 12 that are held in the plurality of cells S of the rotary table 65 are a plurality of types of analysis chips 12 for different measurement items. Accordingly, the plurality of types of analysis chips 12 for the different measurement items can be arranged on the rotary table 65, and thus, the test substance sample can be efficiently analyzed.

In the analyzer 100 according to the present embodiment, each of the plurality of cells S is transferred to the measurement position by rotation of the rotary table 65 in the incubator 60. This enables efficient movement of the cells S while reducing the size of the incubator 60 compared with the case where each of the plurality of cells S is transferred to the measurement position in a linear manner.

In the analyzer 100 according to the present embodiment, each of the analysis chips 12 is a dry analysis chip using a solid-phase reagent as a reagent. The analysis chip 12 each using a solid-phase reagent has not only the reagent but also a plurality of members, such as a case, having different thermal conductivities, and for example, temperature control is more difficult compared to a reagent in a liquid phase. Therefore, by applying the present configuration to the analysis chips 12 each using a solid-phase reagent as a reagent, temperature control of the analysis chips 12 can be facilitated.

Note that, in the above-described embodiment, although a case has been described in which the functional members that also serve as the low thermal conductivity members 65C and 65D are the black density plate 56 and the white density plate 58, the technology of the present disclosure is not limited to this. Each of the functional members may be any member having a function other than low thermal conductivity, and such a member may be, for example, an electrode member having a function of ensuring electrical connection with the rotary table 65, a fixing member having a function of fixing a measurement unit to the rotary table 65, and/or a thermostat having a function of serving as a safety device that prevents an excessive increase in the temperature of the rotary table 65.

In the above-described embodiment, although a case has been described in which thermal conduction from the cells S1 to S9 and S11 to S14 to the cell S10 is suppressed by the low thermal conductivity members 65C and 65D, the technology of the present disclosure is not limited to this. For example, a configuration may be employed in which thermal conduction from the cells S1 to S9 and S11 to S14 to the cell S10 is suppressed by providing a cooling element (e.g., a Peltier element) on the rotary table 65. In other words, when regions on both sides of the cell S10 are cooled by a cooling element, the heat transferred from the cells S1 to S9 and S11 to S14 is consumed in reheating the regions on both sides of the cell S10. As a result, thermal conduction from the cells S1 to S9 and S11 to S14 to the cell S10 is suppressed.

In the above-described embodiment, although a case has been described in which the measurement using the colorimetric method and the measurement using the electrode method are performed, the technology of the present disclosure is not limited to this. It is sufficient that a plurality of types of measurement methods having different target temperatures for the analysis chips 12 are performed, and for example, measurement using the colorimetric method and measurement using a fluorescence method may be performed.

In the above-described embodiment, although a case has been described in which only the cell S10 is provided in the second cell region SR2, the technology of the present disclosure is not limited to this. The cells S that hold a plurality of the electrolyte chips 12B may be provided in the second cell region SR2.

In the above-described embodiment, although a case has been described in which the discard mechanism 80 is provided outside the rotary table 65, the technology of the present disclosure is not limited to this. The discard mechanism 80 may be provided inside the rotary table 65. In this case, the discard position is provided outside the rotary table 65.

The described contents and illustrated contents given above are detailed descriptions of portions according to the technology of the present disclosure, and are merely examples of the technology of the present disclosure. For example, the descriptions relating to the above-described configurations, functions, operations, and effects are descriptions relating to examples of configurations, functions, operations, and effects of the portions according to the technology of the present disclosure. Consequently, it is needless to say that unnecessary portions may be omitted, new elements may be added, or substitutions may be made to the described contents and illustrated contents given above without departing from the gist of the technology of the present disclosure. In addition, in order to avoid complication and to facilitate understanding of the portions according to the technology of the present disclosure, the described contents and illustrated contents given above exclude descriptions relating to technical common sense and the like that are not particularly necessary for enabling implementation of the technology of the present disclosure.

All documents, patent applications, and technical standards mentioned in the present specification are incorporated herein by reference to the same extent as if each individual document, patent application, or technical standard was specifically and individually indicated to be incorporated by reference.

The disclosure of JP2023-008923 filed on Jan. 24, 2023 is incorporated herein by reference in its entirety.

The following appendixes are further disclosed with respect to the above-described embodiment.

### Appendix 1

An analyzer that analyzes a test substance sample by using a plurality of analysis chips onto which the test substance sample is to be spotted, the plurality of analysis chips being configured to be detachably loaded into the analyzer, the analyzer including:
an incubator having a heater and a table on which a plurality of cells are arranged such that each of the plurality of cells holds one of the plurality of analysis chips, the table being configured to sequentially transfer the plurality of analysis chips to a measurement position, the incubator being configured to heat the plurality of analysis chips held in the plurality of cells by using the heater; and
a measurement unit that is disposed at the measurement position and that measures the test substance sample spotted on the plurality of analysis chips,
wherein the analysis chips include a first analysis chip, a target temperature to which the first analysis chip is to be heated in measurement being a first target temperature that is relatively high, and a second analysis chip, a target temperature to which the second analysis chip is to be heated in measurement being a second target temperature that is relatively lower than the first target temperature, and
wherein the table has, as the cells, a first cell that holds the first analysis chip and in which the first analysis chip is heated by the heater to the first target temperature and at least one second cell that holds the second analysis chip, and the table is provided with a thermal conduction suppressing portion that suppresses thermal conduction from the first cell to the at least one second cell.

### Appendix 2

The analyzer according to Appendix 1,
wherein the thermal conduction suppressing portion is a low thermal conductivity member that has a lower thermal conductivity than the table.

### Appendix 3

The analyzer according to Appendix 2,
wherein the table is a metal, and
wherein the low thermal conductivity member is a resin.

### Appendix 4

The analyzer according to Appendix 2 or Appendix 3,
wherein the table has a first cell region in which a plurality of the first cells are located and a second cell region in which the at least one second cell is located, and
wherein the low thermal conductivity member is provided between the first cell region and the second cell region.

### Appendix 5

The analyzer according to Appendix 4,
wherein the table has a circular shape, and the first cell region and the second cell region are arc-shaped regions arranged circumferentially in the table, and
wherein a plurality of the low thermal conductivity members are provided on both sides of the second cell region.

### Appendix 6

The analyzer according to any one of Appendix 1 to Appendix 5,
wherein the measurement unit includes a first measurement unit that optically measures a reaction state of the first analysis chip by using a colorimetric method as a measurement method and a second measurement unit that measures concentration of an electrolyte contained in the test substance sample by using an electrode, and
wherein the first cell is a cell for use with the colorimetric method, and the at least one second cell is a cell for use with an electrode method.

### Appendix 7

The analyzer according to Appendix 2,
wherein the low thermal conductivity member is also used as a functional member having a function other than low thermal conductivity.

### Appendix 8

The analyzer according to Appendix 7,
wherein the functional member also used as the low thermal conductivity member is an optical density plate having a reference optical density that serves as a standard for comparison in a colorimetric method.

### Appendix 9

The analyzer according to any one of Appendix 1 to Appendix 8,
wherein the plurality of analysis chips held in the plurality of cells of the table are a plurality of types of analysis chips for different measurement items.

### Appendix 10

The analyzer according to any one of Appendix 1 to Appendix 9,
wherein the table is a rotary table and transfers each of the plurality of cells to the measurement position by rotating.

### Appendix 11

The analyzer according to any one of Appendix 1 to Appendix 10,
wherein each of the analysis chips is a dry analysis chip using a solid-phase reagent.

What is claimed is:

1. An analyzer that analyzes a test substance sample by using a plurality of analysis chips onto which the test substance sample is to be spotted, the plurality of analysis chips being configured to be detachably loaded into the analyzer, the analyzer comprising:
an incubator having a heater and a table on which a plurality of cells are arranged such that each of the plurality of cells holds one of the plurality of analysis chips, the table being configured to sequentially transfer the plurality of analysis chips to a measurement position, the incubator being configured to heat the plurality of analysis chips held in the plurality of cells by using the heater; and
a measurement unit that is disposed at the measurement position and that measures the test substance sample spotted on the plurality of analysis chips,
wherein the analysis chips include a first analysis chip, a target temperature to which the first analysis chip is to be heated in measurement being a first target temperature that is relatively high, and a second analysis chip, a target temperature to which the second analysis chip is to be heated in measurement being a second target temperature that is relatively lower than the first target temperature, and
wherein the table has, as the cells, a first cell that holds the first analysis chip and in which the first analysis chip is heated by the heater to the first target temperature and at least one second cell that holds the second analysis chip, and the table is provided with a thermal conduction suppressing portion that suppresses thermal conduction from the first cell to the at least one second cell.

2. The analyzer according to claim 1,
wherein the thermal conduction suppressing portion is a low thermal conductivity member that has a lower thermal conductivity than the table.

3. The analyzer according to claim 2,
wherein the table is a metal, and
wherein the low thermal conductivity member is a resin.

4. The analyzer according to claim 2,
wherein the table has a first cell region in which a plurality of the first cells are located and a second cell region in which the at least one second cell is located, and
wherein the low thermal conductivity member is provided between the first cell region and the second cell region.

5. The analyzer according to claim 4,
wherein the table has a circular shape, and the first cell region and the second cell region are arc-shaped regions arranged circumferentially in the table, and
wherein a plurality of the low thermal conductivity members are provided on both sides of the second cell region.

6. The analyzer according to claim 1,
wherein the measurement unit includes a first measurement unit that optically measures a reaction state of the first analysis chip by using a colorimetric method as a measurement method and a second measurement unit that measures concentration of an electrolyte contained in the test substance sample by using an electrode, and
wherein the first cell is a cell for use with the colorimetric method, and the at least one second cell is a cell for use with an electrode method.

7. The analyzer according to claim 2,
wherein the low thermal conductivity member is also used as a functional member having a function other than low thermal conductivity.

8. The analyzer according to claim 7,
wherein the functional member also used as the low thermal conductivity member is an optical density plate having a reference optical density that serves as a standard for comparison in a colorimetric method.

9. The analyzer according to claim 1,
wherein the plurality of analysis chips held in the plurality of cells of the table are a plurality of types of analysis chips for different measurement items.

10. The analyzer according to claim 1,
wherein the table is a rotary table and transfers each of the plurality of cells to the measurement position by rotating.

11. The analyzer according to claim 1,
wherein each of the analysis chips is a dry analysis chip using a solid-phase reagent.
